(19) United States
(12) Patent Application Publication
(10) Pub. No.: US 2005/0157398 A1
(43) Pub. Date: Jul. 21, 2005

(54) Head-up display mounted in vehicles, vehicles provided with the same and method of manufacturing the vehicles

(76) Inventors: Toshiyuki Nagaoka, Akishima-shi (JP); Hiroshi Kodama, Hachioji-shi (JP)

Correspondence Address: KENYON & KENYON, 1 BROADWAY, NEW YORK, NY, 10004, US

(21) Appl. No.: 11/030,075

(22) Filed: Jan. 7, 2005

(30) Foreign Application Priority Data
Jan. 15, 2004 (JP) 2004-008265

(51) Int. Cl. G02B 27/14

(52) U.S. Cl. 359/630

(57) ABSTRACT

A head-up display mounted in vehicles comprises a display information source, a projecting optical system for projecting a picture image displayed on the display information source toward a windshield of a vehicle, wherein a reflected light from the windshield is led to an eyeball of an observer. The projecting optical system has an optical component for correcting distortion or inclination of the image generated by reflecting the windshield between the windshield and the display information source, and the arrangement of the optical component for correcting distortion can be selected. The holding frame has a holding portion as a positioning structure which enables to select arrangement of the optical component for correction.

The contents of Application No. 2004-8265 filed on Jan 15, 2004, in Japan, are hereby incorporated by reference.

### BACKGROUND OF THE INVENTION

1. Field of the Invention

The present invention relates to a head-up display (henceforth, it is abbreviated as HUD) mounted in vehicles for leading an image to be displayed to observer eyeballs, such as a driver of a vehicle, by reflecting the image displayed in a source of information to be displayed at a windshield of a vehicle, such as an automobile. Furthermore, it relates to a vehicle using the HUD, and a method of manufacturing of the same.

2. Description of the Related Art

Recently, the HUD has been used as a method of offering a picture information to a driver and the like in vehicles. For examples, as disclosed in Japanese published unexamined patent application Toku Kai No. 2003-107391 and Japanese published unexamined patent application Toku Kai No. 2003-287707. The HUD is a device in which an optical picture information projected from a display information source, such as a liquid crystal display etc., is reflected at a windshield and it is lead to an observer's eyeballs, such as an driver etc., in vehicles. By this, the driver can read the information without almost moving a line of sight from operational states.

Furthermore, HUD of a type in which a combiner is arranged at a position before and departed from the windshield, without using reflection at the windshield, and an optical information is lead to a driver's eyeball has been also proposed by HUD in Japanese published unexamined patent application Toku Kai No. 2000-267039, for example.

### SUMMARY OF THE INVENTION

The HUD mounted in vehicles according to the present invention comprises, a display information source (that is, a source of an information to be displayed) and a projecting optical system for projecting a picture image displayed on the display information source toward a windshield of a vehicle, wherein a reflected light from the windshield is led to an eyeball of an observer. The projecting optical system has, between the windshield and display information source, an optical component for correcting distortion or inclination of an image which are generated by reflection on the windshield, wherein arrangement of the optical component for correction can be selected. The HUD mounted in vehicles further comprises a position fixing structure which enables to select arrangement of the optical component for correction.

The vehicle provided with the HUD mounted in vehicles according to the present invention comprises the HUD mounted in vehicles of the present invention, a vehicle speed sensor, and a processing apparatus in which a display information by the display information source of the HUD mounted in vehicles can be changed on the basis of the measurement value measured by the HUD mounted in vehicles.

Two or more HUDs mounted in vehicles according to the present invention comprises, a display information source and a projecting optical system for projecting a picture image displayed on the display information source toward a windshield of a vehicle, wherein a reflected light from the windshield is led to an eyeball of an observer. Here, when one of the two or more HUDs mounted in vehicles is made as a first HUD mounted in vehicles and other one is made as a second HUD mounted in vehicles, a part of optical components allotted in an optical path of the projecting optical system arranged at the first HUD mounted in vehicles is an optical component having an optical surface configuration which is almost same to that of a part of optical components allotted to an optical path of the projecting optical system arranged at the second HUD mounted in vehicles. Other optical components except an optical component having almost same optical surface configuration out of the projecting optical systems in the first and second HUD mounted in vehicles is composed of an optical component for correcting distortion or inclination of an image after reflecting the windshield by having a mutually different optical surface configurations.

According to the present invention, HUD mounted in vehicles, by which a good image or an image according to liking of a user can be observed without being influenced by the difference of the form of a windshield and which can be widely used, can be provided, although the HUD is such type that an image displayed in an information source is reflected at a windshield of a vehicle, and a vehicle provided with the HUD mounted in vehicles mentioned above can be provided.

Furthermore, according to the present invention, manufacturing cost of a vehicle provided with the HUD can be reduced.

These and other advantages and features of the present invention will become apparent from the following detailed description of the preferred embodiments when take in conjunction with the accompanying drawings.

### BRIEF DESCRIPTION OF THE DRAWINGS

FIG. 1 is an outline explanatory diagram showing a principal part of a vehicle provided with a HUD in vehicles of a first embodiment according to the present invention.

FIG. 2 is an outline perspective diagram showing a position fixing structure of the optical component for correction in a HUD in the vehicle of the first embodiment.

FIGS. 3A to 3E are perspective diagrams showing mutually different examples of composition of the optical component for correction in a HUD of the first embodiment.

FIG. 4A is an explanatory diagram showing sketchily differences of form in the perpendicular direction of the windshield according to differences by a type of vehicle.

FIG. 4B is an explanatory diagram showing an example of a correcting lens used for vehicles, such as a track and a bus.

FIG. 4C is an explanatory diagram showing an example of the correcting lens used for vehicles, such as a sports car.

FIG. 5 is an explanatory diagram showing sketchily the difference of form in the horizontal direction of the windshield according to differences by a type of vehicle.

FIGS. 6A, 6B, and 6C are conceptual diagrams showing a manufacturing process of the vehicle provided with the HUD, a manufacturing process of a sports car, a manufacturing process of a saloon, and a manufacturing process of a track are shown, respectively.

### DETAILED DESCRIPTION OF THE PREFERRED EMBODIMENTS

Prior to explaining embodiments, reasons why the composition of the present invention has been made as well as function and advantages of the present invention will be explained.

The HUD mounted in vehicles according to the present invention comprises an optical component for correction for correcting distortion or inclination of an image which are generated by reflecting the windshield in an optical path between the windshield and the display information source, where arrangement of the optical component for correction can be selected. The HUD mounted in vehicles is provided with a position fixing structure which enables to select arrangement of the optical component for correction.

Form and inclination of a windshield may change according to types of vehicles. Therefore, different distortion and inclination of an image are generated by difference of the form of the windshield.

According to the present invention, it becomes possible to correct distortion and inclination generated by the difference of the form of the windshield and to obtain the observation image which suited liking of a user, since arrangement of the optical component for correction for correcting distortion and inclination of an image can be selectively changed.

Furthermore, if in the HUD mounted in vehicles of the present invention, the projecting optical system has a main optical component having a main power, different from the optical component for correction, a HUD mounted in vehicles which has more sufficient visibility than a HUD having only a main optical component and a windshield can be attained. Moreover, by composing that the main optical component is arranged in one with the source of information to be displayed, arrangement on a dashboard of a vehicle become easy.

In the HUD mounted in vehicles of the present invention, if the optical component for correction has an optically functional surface which deflects a chief ray of an optical component having main power, correction of an image by the difference of inclination of the windshield can be performed.

In the present invention, the chief ray is defined as a ray which extends to a center of an effective surface the optical component for correction, among rays emanated from the center of the display information source.

Generally, the windshield of a vehicle has a concave form where curvatures in perpendicular direction and horizontal direction are different for keeping a space of a room and for mitigating air resistance. Moreover, the inclination of a surface is composed so as to be inclined to a driver's line of sight in the perpendicular direction as well as in the horizontal direction.

Therefore, in the HUD mounted in vehicles of the present invention, if the optical component for correction is composed to have an optically functional surface which is rotationally asymmetric, correction of inclination and distortion of an image surface becomes easier.

In the HUD mounted in vehicles of the present invention, if a diffraction lens surface having an optical function which is rotationally asymmetric is used for an optically functional surface of the optical component for correction, a surface configuration can be formed macroscopically almost flat plane. If the optically functional surface is formed on the diffraction lens surface having a curved surface configuration, correction of chromatic aberration etc., can be performed easier. And, since processing at the time of forming a rotationally asymmetric and optically functional surface can also be performed by a pattern on an optical surface, processing becomes easy.

In the HUD mounted in vehicles according to the present invention, by composing such that the optical component for correction has an entrance surface of transmission and an exit surface of transmission, while it does not have a reflecting surface, composition of the optical component for correction can be simple.

In the HUD mounted in vehicles according to the present invention, by composing such that arrangement of the optical component for correction may be selectively changed so as to change an effect by correction, correction of distortion and inclination of the observation image in two or more types of vehicles can be performed by one optical component for correction.

In the HUD mounted in vehicles according to the present invention, if the optical component for correction is located under the windshield and it is also used for a cover component of the HUD, the number of parts can be reduced. Correction of distortion of an image can be performed very near the windshield which causes to generate distortion. Therefore, it becomes easy to perform correction of distortion.

In the HUD mounted in vehicles according to the present invention, if a surface at the windshield side, of the optical component for correction is formed as a flat plane, adhesion of dust can be suppressed since a surface configuration facing the open air becomes as a flat plane. Moreover, since appearance can be unified irrespective of the type of correcting lens, it is good for design.

Inside of a vehicle is a place where the variation of temperature or air moisture is large by operation of an air-conditioner. Therefore, in the HUD mounted in vehicles according to the present invention, it is desirable to use a glass material as an optical material used for an optical component for correction in order to diminish deterioration of the optical performance by temperature-humidity change. Particularly, it is desirable to use glass as a base material since the temperature and the humidity easily change by sunlight if an optical component for correction is used also for a cover component.

In the HUD mounted in vehicles according to the present invention, it is desirable that the optical component for correction has coating film which diminishes a reflectivity on the surface. A reflected image may be troublesome when direct rays hit and reflect in the optical component for correction. However, such troublesomeness can be diminished if coating which diminishes reflectivity on the surface of the optical component for correction is performed. Particularly, if the surface is made into a flat plane when an optical component for correction is used as a cover component, film thickness of the coating film can be easily uniformed.

In the HUD mounted in vehicles according to the present invention, if the optical component for correction is composed of a lens, and at least a part of optically functional surfaces other than the transmission surface of the lens is provided with a reflection suppressing component, reflection can be diminished and generating of a ghost image can be diminished. As a reflection suppressing component, it is good to use a frame, black paint, etc.

Like a vehicle according to the present invention, by composing such that a HUD mounted in vehicles, a vehicle speed sensor, and a processing apparatus which changes an information to be displayed by the display information source of the two or more HUDs mounted in vehicles on the basis of the measurement value measured by the vehicle speed sensor are comprised, a speed of the vehicle is measured by the vehicle speed sensor, and information of the measurement result can be transmitted to a driver by the HUD. Furthermore, it becomes possible to reduce movement of a driver's line of sight and to deliver vehicle speed information.

In two or more HUDs mounted in vehicles according to the present invention, each of the HUDs comprises a display information source and a projecting optical system for projecting a picture image displayed on the display information source toward a windshield of a vehicle, wherein a reflecting light from the windshield is led to an eyeball of an observer. Here, when one of the two or more HUDs mounted in vehicles is made as first HUD mounted in vehicles and other one is made as the second HUD mounted in vehicles, a part of optical components allotted in an optical path of the projecting optical system arranged at the first HUD mounted in vehicles is an optical component having an optical surface configuration which is almost same to that of a part of optical components allotted to an optical path of the projecting optical system arranged at the second HUD mounted in vehicles, wherein other optical components except an optical component having almost same optical surface configuration out of the projecting optical systems in the first and the second HUD mounted in vehicles is composed of an optical component for correcting distortion and inclination of an image after reflecting the windshield by having a mutually different optical surface configurations. Thus, by composing such that some part of optical components are used in common in the first HUD mounted in vehicles and in the second HUD mounted in vehicles, and different optical components are allotted in each HUD, a HUD mounted in vehicles in which correction of distortion and inclination have been made so as to correspond to a form of a windshield can be offered. Since some part of optical components are used in common, the manufacturing process of the optical components can be made in common. Accordingly a manufacturing cost can be suppressed at a low price.

Also, in two or more HUDs mounted in vehicles according to the present invention, the same functions and effects mentioned above can be acquired by using the same HUD mounted in vehicles according to the present invention.

Then, by composing that a vehicle is provided with one of the two or more HUDs mounted in vehicles according to the present invention, a vehicle speed sensor, and a processing apparatus which changes a display information by the display information sources of the one of the two or more HUDs mounted in vehicles, on the basis of the measurement value measured by the vehicle speed sensor, a vehicle provided with a HUD having good visibility, in which correction to difference corresponding to a form of a windshield according to the type of vehicles has been performed can be offered. The speed of a vehicle is measured by a vehicle speed sensor, and information of the measurement result can be transmitted to a driver via the HUD. Moreover, a movement of a driver's line of sight is reduced, and vehicle speed information can be delivered to the driver.

Furthermore, in the method of manufacturing the vehicle provided with the HUD mounted in vehicles according to the present invention, it is made to have a production process in which an optical component for correction is arranged to a positioning structure of a holding frame, inside of which a display information source and an optical component are arranged, and a production process in which the holding frame is arranged to a dashboard of a vehicle before or after the production process mentioned above.

### The First Embodiment

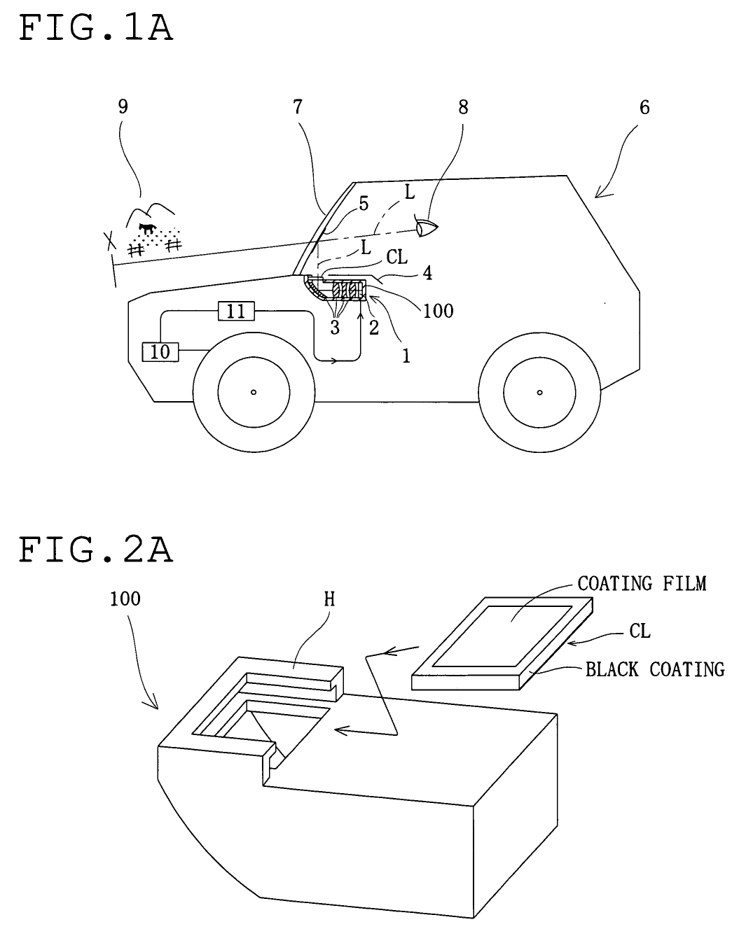

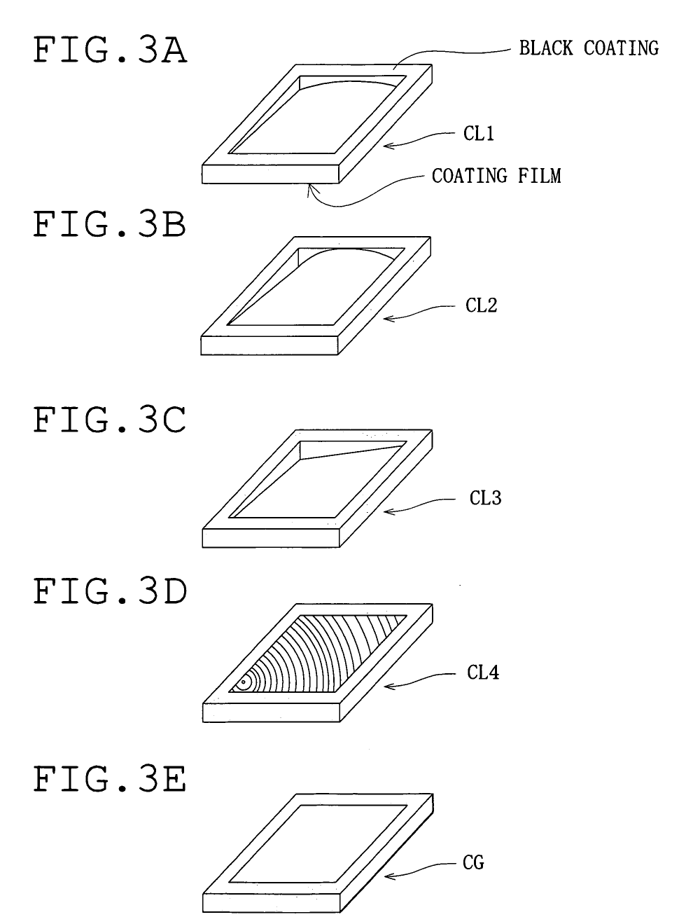

Hereafter, embodiments of the present invention will be explained using drawings. FIG. 1 is an explanatory drawing showing sketchily the principal part of a vehicle equipped with a HUD mounted in vehicles concerning a first embodiment according to the present invention. FIG. 2 is an outline perspective diagram showing the positioning configuration of the optical component for correction in the HUD mounted in vehicles concerning the first embodiment. FIGS. 3A to 3E are outline perspective diagrams showing different examples of the composition of the optical component for correction in the HUD mounted in vehicles concerning the first embodiment.

In FIG. 1, numerical symbol 1 represents a display unit. The display unit 1 has a display information source 2 which consists of a backlighted dot display type liquid crystal element for example, an optical component 3 which consists of a lens, a curved surface mirror, etc., a correcting lens CL, and a holding frame 100.

The optical component 3 and the correcting lens CL compose a projection optical system. The projection optical system projects a picture image displayed on the display information source 2 to a windshield 7 of a vehicle 6. The optical component 3 is arranged in the holding frame 100 in one with the display information source 2.

The display unit 1 is laid under the inside of a dashboard 4. Here, the a display unit 1 can be mounted so as to enable to be attached or detached at the inside of the dashboard 4 or on the dashboard 4 so that replacement of the unit can be made on two or more vehicles.

Numerical symbol 5 represents a half-transmission-reflection type combiner arranged at a windscreen surface in one, in a predetermined portion of the internal surface of the windscreen 7 of a vehicle 6. The combiner 5 is composed such that a light emanated from the front side of the vehicle 6 is penetrated to a side of a driver 8, while a display light L from the display unit 1 is reflected to the side of the driver 8.

In addition, the vehicle 6 is provided with a speed sensor 10 which detects the running speed of the vehicle. Any type of speed sensor can be used as the speed sensor 10, as long as it has a composition which detects the speed of the vehicle 6, such as a composition which detects the speed by the number of rotations of the axle of the vehicle 6, a composition which detects the speed based on the signal from a satellite, and the like. A speed signal detected by the speed sensor 10 is output to a controlling circuit 11.

The controlling circuit 11 is connected with the display information source 2, and it is composed so that the speed detected through the speed sensor 10 may be displayed through the display information source 2.

Here, the display unit 1 of this embodiment is composed so as to enable to adjust an image forming condition of a display image X, which is formed overlapped with scenery 9 in front of the vehicle 6 by a display light L irradiated to the combiner 5. That is, at an exit side of the housing of the display unit 1, a slide type holding portion H is arranged so as to enable to take out and insert a correcting lens CL for correcting distortion and inclination of an image generated by difference of the form of the windshield 7 when reflection is made. The holding portion H is composed so that a plane parallel cover glass CG can be also inserted when correction is not necessary. The holding portion H is composed so that various types of correcting lenses can be chosen and inserted in order to diminish a remaining decentering aberration which cannot be completely corrected by adjusting the position of the display unit.

FIGS. 3A to 3E are diagrams showing examples of composition of mutually different correcting lenses which can be attached to and detached from the holding portion H.

Each correcting lens shown in FIGS. 3A to 3D is composed as a rotationally asymmetric correcting lens to each optical axis, respectively. A surface at the windshield side of each correcting lens is formed as a plane.

In FIGS. 3A to 3E, a surface at underside is shown as a surface (plane) of the windshield side of a correcting lens, for convenience.

As for the correcting lenses CL1 and CL2 shown in FIGS. 3A to 3B, a surface of the opposite side to the windshield is formed as a curved surface. The correcting lenses CL1 and CL2 are composed that inclination angles of the surface of a center position and the degree of a variation of curved surface configuration differ respectively, so as to enable to select suitably correction of distortion etc. Peripheral portion of the correcting lens is formed in the shape of a frame, on which black-finished coating for diminishing reflection is performed. Moreover, each correcting lenses CL1 and CL2 is composed such that insertion into the holding portion can be made from any directions such as transverse direction, backward direction, front direction or their reversed direction, besides a direction shown by an arrow head mark in FIG. 2, and accordingly four kinds of correction of distortion and inclination of an image can be made by one correcting lens.

As for a correcting lens CL3 shown in FIG. 3C, a surface at the windshield side is formed as a plane, and a surface of an opposite side to the windshield is formed as a surface having inclination in the lengthwise direction and the transverse direction.

As for a correcting lens CL4 shown in FIG. 3D, a surface at the windshield side is formed in a plane, and a surface at an opposite side of the windshield is formed in a diffraction lens surface. On the diffraction lens surface of the correcting lens CL4, a diffraction pattern of a concentric circle which has a center in the position off the optical axis of the optical component 3 composing the main optical system shown in FIG. 1. is formed. As a matter of course, the diffraction lens surface of the correcting lens CL4 can be composed of a surface which has an optical function such as a cylindrical lens and a toric lens.

Thus, the correcting lens used for the first embodiment can be composed of a various type of lenses having an optical surface with a rotationally asymmetric optical function so that distortion and inclination of different images according to difference of a form of the windshield can be corrected. And concretely, it is desirable that as the correcting lens used for the first embodiment, a cylindrical lens, a toric lenses, and a lens which is composed that an aspherical surface component is further added to these lenses. Furthermore, it can be composed so that these surfaces are inclined.

In order to correspond to the difference of the form of the windshield 7, it is desirable that an optical surface is formed as a curved surface having only one symmetrical surface, or as a curved surface in which the number of symmetrical surface is zero.

Here, the optimal composition corresponding to types of vehicles in the correcting lens CL which can be selected and arranged will be explained in full detail.

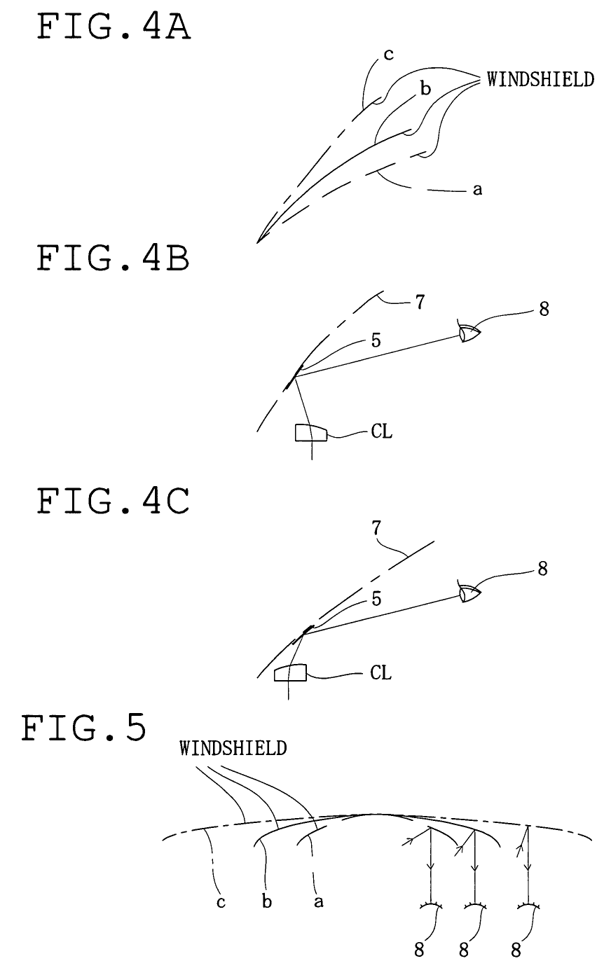

Generally, the form of a windshield differs according to types of a vehicle. For example, difference of the form in the perpendicular direction to the windshield by the difference of types of vehicles is sketchily shown in FIG. 4A. When a windshield of generally medium size vehicles, such as a saloon, is made as a basis (shown by continuous line b), a windshield of large-size vehicles, such as a track and a bus, has a form (shown by an alternate long and short dash line c) which has inclination nearly perpendicular to a road surface compared with the medium size automobile, and a windshield of small-size vehicles, such as a sports cars has a form (shown by broken line a) which has inclination nearly horizontal to a road surface compared with a case of the medium size vehicles. Therefore, when a display unit correcting distortion and inclination of the image generated by reflecting the windshield in medium-size vehicles, such as a saloon, by using a predetermined correcting lens, is used as the basis, it is desirable to adjust the image by using the following correcting lens with respect to a vertical direction.

That is, in case of a track, a bus, etc., a correcting lens having a wedge type cross section form where the front side of a lens becomes thick is used (refer to FIG. 4B). In case of a saloon, the correcting lens having a form in which a front and rear surface of a lens are parallel is used. Otherwise, the correcting lens is not used. In case of a sports car, the correcting lens having a wedge type cross section form where the front portion of a lens becomes thin is used (refer to FIG. 4C).

With respect to the horizontal direction of a windshield, a horizontal inclination also changes by types of vehicles. For example, the difference in the form in the horizontal direction of the windshield by the difference of types of vehicles is sketchily shown in FIG. 5. When the windshield of general medium size vehicles, such as a saloon, is made as a basis (shown by a continuous line b), the windshield of a large-size vehicle, such as a track or a bus has a form where the degree of inclination (curvature) is small (shown by an alternate long and short dash line c), compared with the case of a medium size vehicle, and the windshield of a small-size vehicle, such as a sports car, has a form where a degree of inclination (curvature) is large(shown by a broken line a), compared with the case of medium size vehicles.

Therefore, when it is applied for a different type of vehicles on the basis of the display unit for which distortion and inclination of an image generated by reflecting the windshield in a medium-size vehicle, such as a saloon, have been corrected by a predetermined correcting lens, it is desirable that with respect to the horizontal direction, adjustment of the image is made by using a different type of correcting lenses as well as in the case of vertical direction mentioned above.

Thus, when an attention is paid to distortion of an image, a configuration of a curved surface of the windshield differs according to types of vehicle, in a horizontal direction and a vertical direction to a road surface. Accordingly, distortion and inclination generated by reflecting at the windshield differs. Therefore, it is desirable that correcting lenses having various curved surfaces corresponding to various surface configurations are prepared, and correction is performed according to types of vehicles. A correcting lens can be composed to have a rotationally asymmetric optical surface, where a function of distortion correction is added to an optical surface based on a wedge shape.

In addition, a base material of the correcting lens CL used in the first embodiment is glass, and black painting is made around an effective surface for diminishing reflection as mentioned above. Furthermore, a coating film for diminishing reflection is carried out on a plane at the windshield side of the correcting lens CL.

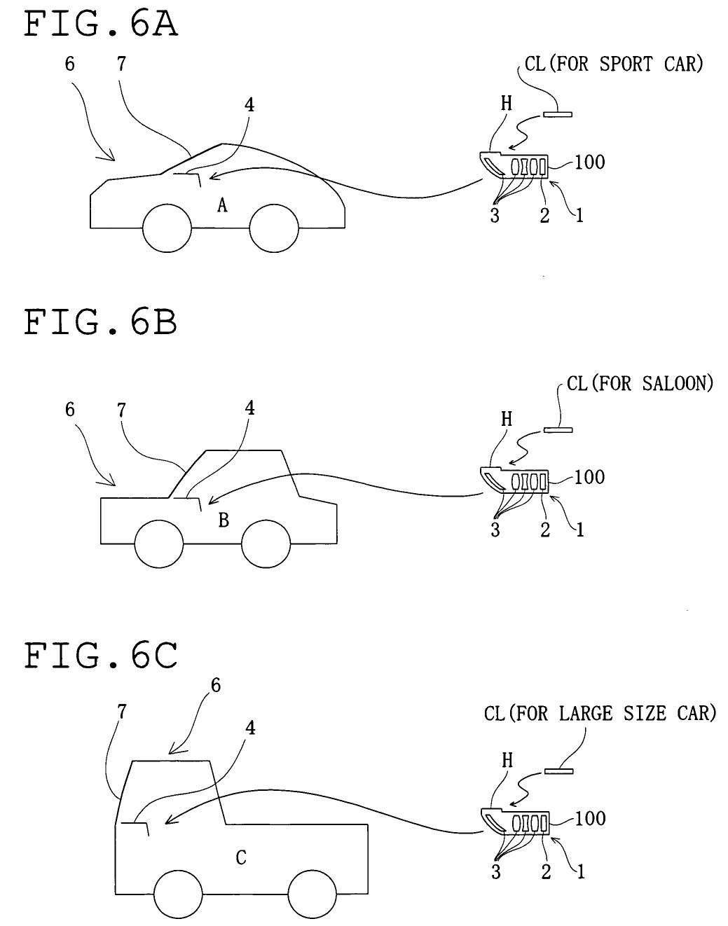

FIG. 6 is a conceptual diagram showing a manufacturing process of a vehicle provided with the HUD mounted in vehicles according to the present invention. FIG. 6A shows a manufacturing process in a sports car. FIG. 6B shows a manufacturing process in a saloon. FIG. 6C shows a manufacturing process in a track.

Vehicle A (sports car), vehicle B (saloon), and vehicle C (track) are different type of vehicles, equipped with a windshield, each form of which is different, respectively.

A holding frame 100 shown in FIG. 1 in each vehicle is equipped with an optical component 3 which consists of two or more lenses and a reflecting surface having almost common surface configuration produced by common manufacturing process. The display information source 2 produced through the common manufacturing process is arranged at the holding frame 100. And the display unit 1 is composed so that the display information source 2 and the optical component 3 are formed in one at the holding frame 100. This composition is produced beforehand.

The holding frame 100 has the holding portion H shown in FIG. 2. For example, in case that the display unit 1 is mounted in the vehicle A, the correcting lens CL for the vehicle A which has been designed and manufactured beforehand so that a good image may be obtained when it is mounted in the vehicle A is inserted into the holding portion H. Then, the display unit 1 in which the correcting lens CL for vehicle A has been inserted is arranged to a dashboard of the vehicle A, and such arrangement is adjusted so that a position of the windshield 7 (the combiner 5 arranged at the windshield) may be set at optimal position.

Also in vehicle B and vehicle C, the correcting lens CL which has been designed and manufactured beforehand for the vehicles B and C respectively, is inserted in the holding portion H. Then, the display unit 1 in which the correcting lens CL for the vehicles B and C has been inserted is arranged to the dashboard of the vehicle A and the dashboards of the vehicles B and C, and then the position is adjusted.

In any type of the display unit, such as a type in which it is arranged at upward of the dashboard, a type arranged at the inside of the dashboard or a type arranged at the bottom of the dashboard, the correcting lens CL suitable for correction of an image in each case is chosen and used.

The display unit 1 is attached beforehand on the dashboard of a vehicle, and then a correcting lens CL which displays a favorable image can be selected and arranged, by checking visually a suitable correcting lens CL while observing an image.

Furthermore, the HUD mounted in vehicles according to the present invention is not limited to the compositions of the embodiments mentioned above, and various modified compositions can be made. For example, as a display information source, a reflection type display apparatus that reflects the light from a display surface side can be used. Furthermore, in order to check a backward image of a vehicle, it can be composed that a camera which picks up the backward image of the vehicle is mounted and connected to the display information source of a HUD so as to enable to observe the backward image of the vehicle.

1. A head-up display mounted in vehicles comprising:
a display information source, and
a projecting optical system for projecting a picture image displayed on the display information source toward a windshield of a vehicle, wherein a reflecting light from the windshield is led to an eyeball of an observer,
wherein the projecting optical system has, between the windshield and the display information source, an optical component for correcting distortion or inclination of an image generated by reflection on the windshield, so that it can be selectively arranged, and
the head-up display mounted in vehicles has a position fixing structure which enables to select arrangement of the optical component for correction.

2. The head-up display mounted in vehicles according to claim 1,
wherein the projecting optical system comprises a main optical component which has main power independently from the optical component for correction, and
the main optical component is arranged in one with the display information source.

3. The head-up display mounted in vehicles according to claim 2, wherein the optical component for correction has an optically functional surface which deflects a principal ray of the main optical component.

4. The head-up display mounted in vehicles according to claim 1, wherein the optical component for correction has a rotationally asymmetric and optically functional surface.

5. The head-up display mounted in vehicles according to claim 4, wherein the optically functional surface of the optical component for correction is a diffraction lens surface which performs a rotationally asymmetric optical function.

6. The head-up display mounted in vehicles according to claim 1, wherein the optical component for correction has an entrance surface of transmission and an exit surface of transmission, but does not have a reflecting surface.

7. The head-up display mounted in vehicles according to claim 6, wherein the optical component for correction is arranged to change an effect of correction by changing a direction of its arrangement.

8. The head-up display mounted in vehicles according to claim 1, wherein the optical component for correction is located under the windshield, and also used as a cover component of the head-up display.

9. The head-up display mounted in vehicles according to claim 8, wherein a surface at the windshield side of the optical component for correction is formed flat.

10. The head-up display mounted in vehicles according to claim 1, wherein the optical component for correction is composed of glass as a base material.

11. The head-up display mounted in vehicles according to claim 1, wherein the optical component for correction has a coating film for diminishing reflectivity on the surface.

12. The head-up display mounted in vehicles according to claim 10, wherein the optical component for correction is composed of a lens and provided with a reflection suppressing component, at least on a part of an optically functional surface other than a transmission surface of the lens.

13. A vehicle comprising the head-up display mounted in vehicles according to claim 1,
a vehicle speed sensor, and
a processing apparatus in which a display information by the display information source of the head-up display mounted in vehicles can be changed on the basis of a measurement value measured by the vehicle speed sensor.

14. Two or more head-up displays mounted in vehicles, each of which comprises a display information source and a projecting optical system for projecting a picture image displayed on the display information source toward a windshield of a vehicle, wherein a reflecting light from the windshield is led to an eyeball of an observer,
wherein, when one of the two or more head-up displays mounted in vehicles is made as a first head-up display mounted in vehicles and other one is made as a second head-up display mounted in vehicles,
a part of optical components allotted in an optical path of the projecting optical system arranged at the first head-up display mounted in vehicles is an optical component having an optical surface configuration which is almost same to that of a part of optical components allotted to an optical path of the projecting optical system arranged at the second head-up display mounted in vehicles, and
other optical components except an optical component having almost same optical surface configuration out of the projecting optical systems in the first and the second head-up display mounted in vehicles is composed of an optical component for correcting distortion or inclination of an image after reflecting the windshield by having a mutually different optical surface configurations.

15. The two or more head-up displays mounted in vehicles according to claim 14, wherein the optical component having an optical surface configuration which is almost same is a main optical component having main power different from the optical component for correction, and the main optical component is arranged in one with the display information source.

16. The two or more head-up displays mounted in vehicles according to 15, wherein at least one of the optical components for correction has an optically functional surface for deflecting a chief ray of the main optical component.

17. The two or more head-up displays mounted in vehicles according to claim 14, wherein at least one of the optical components for correction has a rotationally asymmetric and optically functional surface.

18. The two or more head-up displays mounted in vehicles according to claim 17, wherein at least one of optically functional surfaces of the optical component for correction is a diffraction lens surface which performs a rotationally asymmetric optical function.

19. The two or more head-up displays mounted in vehicles according to 1, wherein the optical component for correction has an entrance surface of transmission and an exit surface of transmission, but does not have a reflective surface.

20. The two or more head-up displays mounted in vehicles according to claim 14, wherein at least one of the optical components for correction is composed so that at least one of the optical components for correction can be arranged selectively to change an effect by changing a direction of its arrangement.

21. The two or more head-up displays mounted in vehicles according to claim 14, wherein the optical component for correction is located under the windshield and also used for a cover component of the head-up display.

22. The two or more head-up displays mounted in vehicles according to claim 21, wherein a surface at the side of the windshield of the optical component for correction is a flat plane.

23. The two or more head-up displays mounted in vehicles according to claim 14, wherein the optical component for correction is composed of glass as a base material.

24. The two or more head-up displays mounted in vehicles according to claim 14, wherein the optical component for correction has a coating film for reducing a reflection factor on the surface.

25. The two or more head-up displays mounted in vehicles according to claim 23, wherein the optical component for correction is composed of a lens and has a reflection suppressing component, at least on a part of optically functional surface other than the transmission surface of the lens.

26. A vehicle comprising one of the two or more head-up displays mounted in vehicles according to claim 14, a vehicle speed sensor and a processing apparatus which changes a display information by the display information source of the one of the two or more head-up displays mounted in vehicles on the basis of the measurement value measured by the vehicle speed sensor.

27. Method of manufacturing a vehicle provided with a head-up display mounted in vehicles comprising,
a production process for arranging an optical component for correction to a positioning structure of a holding frame in which a display information source and an optical component are provided, and
a production process in which, before or after the process for arranging the optical component for correction, the holding frame is arranged to a dashboard of the vehicle.
